(19) United States
(12) Patent Application Publication
(10) Pub. No.: US 2018/0349669 A1
(43) Pub. Date: Dec. 6, 2018

(54) OPERATING METHOD OF OPTICAL FINGERPRINT SENSOR, OPERATING METHOD OF ELECTRONIC DEVICE INCLUDING THE OPTICAL FINGERPRINT SENSOR, AND DISPLAY DEVICE INCLUDING THE OPTICAL FINGERPRINT SENSOR

(71) Applicant: SAMSUNG ELECTRONICS CO., LTD., Suwon-si (KR)

(72) Inventors: Sun-kwon KIM, Yongin-si (KR); Se-woong AHN, Hwaseong-si (KR); Yoon-kyung CHOI, Seoul (KR); Min-gyu KIM, Seongnam-si (KR)

(73) Assignee: SAMSUNG ELECTRONICS CO., LTD., Suwon-si (KR)

(21) Appl. No.: 15/976,492

(22) Filed: May 10, 2018

(30) Foreign Application Priority Data
Jun. 2, 2017 (KR) 10-2017-0069277
Nov. 3, 2017 (KR) 10-2017-0146177

(51) Int. Cl. G06K 9/00; G06F 3/041

(52) U.S. Cl. CPC G06K 9/00013; G06F 2203/04101; G06K 9/001; G06F 3/041

(57) ABSTRACT

An operating method of an optical fingerprint sensor, an operating method of an electronic device including the optical fingerprint sensor, and a display device including the optical fingerprint sensor are disclosed. The method of operating a fingerprint sensor, wherein the fingerprint sensor senses a fingerprint image based on light reflected from a fingerprint, may include transmitting a first signal indicating a first request to turn on light emission, to a display driving circuit which drives a display panel disposed on the fingerprint sensor, scanning an object on the display panel, based on light irradiated from the display panel, and transmitting, to the display driving circuit, a second signal indicating a second request to turn off the light emission.

### CROSS-REFERENCE TO RELATED APPLICATIONS

This application claims priority from Korean Patent Application No. 10-2017-0069277, filed on Jun. 2, 2017, and Korean Patent Application No. 10-2017-0146177, filed on Nov. 3, 2017 in the Korean Intellectual Property Office, the disclosures of which are incorporated herein in their entireties by reference.

### BACKGROUND

### 1. Field

Apparatuses and methods consistent with example embodiments relate to a fingerprint sensor, and more particularly, to an operating method of an optical fingerprint sensor, an operating method of an electronic device including the optical fingerprint sensor, and a display device including the optical fingerprint sensor.

### 1. Description of the Related Art

Recently, as wired/wireless communication technology and smart device-related technology advance rapidly, fingerprint recognition of a user is being widely adopted to perform user authentication to ensure secure use of these devices. In mobile devices such as smartphones and tablet personal computers (PCs), on-display fingerprint sensors, where a fingerprint sensor is embedded in a touch screen (or a display), may greatly increase convenience of use while reducing the size requirement.

### SUMMARY

One or more example embodiments provide an operating method of an optical fingerprint sensor and an operating method of an electronic device including the optical fingerprint sensor, which reduce current consumption, and a display device including the optical fingerprint sensor, which prevents deterioration of pixels of a display panel providing light to the optical fingerprint sensor.

According to an aspect of an example embodiment, there is provided an operating method of a fingerprint sensor, wherein the fingerprint sensor senses a fingerprint image based on light reflected from a fingerprint. The operating method may include transmitting a first signal indicating a first request to turn on light emission, to a display driving circuit which drives a display panel disposed on the fingerprint sensor, scanning an object on the display panel, based on light irradiated from the display panel, and transmitting, to the display driving circuit, a second signal indicating a second request to turn off the light emission.

According to an aspect of an example embodiment, there is provided a display device including a display panel including a plurality of pixels, a display driving circuit configured to drive the display panel to display an image, and a fingerprint sensor disposed under the display panel and configured to sense a fingerprint, based on light emitted from at least one of the plurality of pixels of the display panel by controlling turning-on and turning-off of light emission of the display panel.

According to an aspect of an example embodiment, there is provided an operating method of an electronic device including a touch screen and a fingerprint sensor stacked on the touch screen. The operating method may include transmitting, by the fingerprint sensor, a light-on request signal to a display driving circuit which drives a display layer of the touch screen, turning on, by the display driving circuit, light emission of the display pixels provided in at least one area of a fingerprint sensing area of the touch screen, based on the light-on request signal, and scanning, by the fingerprint sensor, an object on the touch screen, based on light irradiated from the touch screen.

According to an aspect of an example embodiment, there is provided a method of operating a fingerprint sensor to identify a fingerprint. The method may include obtaining a sensing signal from one direction of a pixel array, analyzing, by an image processor, frequency components of the sensing signal, and determining, by a processor, whether an object contacting a fingerprint sensing area is a fingerprint of a person, based on a frequency component corresponding to a first frequency band among the frequency components of the sensing signal.

### BRIEF DESCRIPTION OF THE DRAWINGS

The above and/or other aspects will become apparent and more readily appreciated from the following detailed description of example embodiments, taken in conjunction with the accompanying drawings in which:

FIG. 1 illustrates a display device according to an example embodiment;

FIG. 2 illustrates an example of a vertical cross-sectional view taken along line A-A′ in a fingerprint sensor of the display panel of FIG. 1;

FIG. 3 is a diagram for describing an operation of each of a fingerprint sensor and a display driving circuit, according to an example embodiment;

FIG. 4 is a diagram illustrating an operation of each of the fingerprint sensor and the display driving circuit of FIG. 3 with respect to time;

FIG. 5 is a flowchart illustrating an operation of each of a fingerprint sensor and a display driving circuit, according to an example embodiment;

FIG. 6 is a diagram for describing an operation of each of a fingerprint sensor and a display driving circuit, according to an example embodiment;

FIG. 7 is a flowchart illustrating an operation of each of a fingerprint sensor and a display driving circuit, according to an example embodiment;

FIG. 8 illustrates an example embodiment of a fingerprint sensor;

FIG. 9 illustrates an example embodiment of a display driving circuit;

FIG. 10 illustrates a touch screen device according to an embodiment;

FIG. 11 illustrates, as an example, a vertical cross-sectional view taken along line A-A′ in a fingerprint sensor of the touch screen panel of FIG. 10;

FIGS. 12A, 12B, and 12C are diagrams for describing a method of receiving, by a fingerprint sensor, a sensing request signal from a touch controller;

FIG. 13 is a block diagram illustrating a mobile device according to an example embodiment;

FIGS. 14 and 15 are flowcharts illustrating an operation of each of elements of the mobile device of FIG. 13;

FIG. 16 is a diagram illustrating a portion of a fingerprint of a person;

FIG. 17A is a diagram showing a signal intensity of an ideal fingerprint pattern on a frequency domain, and FIG. 17B is diagram showing a signal intensity of the exemplary fingerprint sensing signal on a frequency domain.

FIG. 18 is a flowchart for describing a method of determining whether an object on a fingerprint sensing area is a fingerprint, according to an example embodiment;

FIGS. 19A and 19B are diagrams illustrating directions in which a plurality of sensing signals are obtained in a fingerprint sensing area;

FIG. 20 is a diagram illustrating a method of obtaining a plurality of sensing signals in a plurality of areas corresponding to a plurality of directions in a fingerprint sensing area;

FIG. 21 is a flowchart for describing a method of determining whether an object on a fingerprint sensing area is a fingerprint, according to an example embodiment;

FIG. 22 represents diagrams showing a signal intensity of each of a plurality of sensing signals on the frequency domain;

FIG. 23 is a flowchart for describing a method of determining whether an object on a fingerprint sensing area, according to an example embodiment; and

FIG. 24 is a diagram illustrating a smartphone according to an example embodiment.

### DETAILED DESCRIPTION OF THE EMBODIMENTS

Hereinafter, various example embodiments will be described with reference to the accompanying drawings.

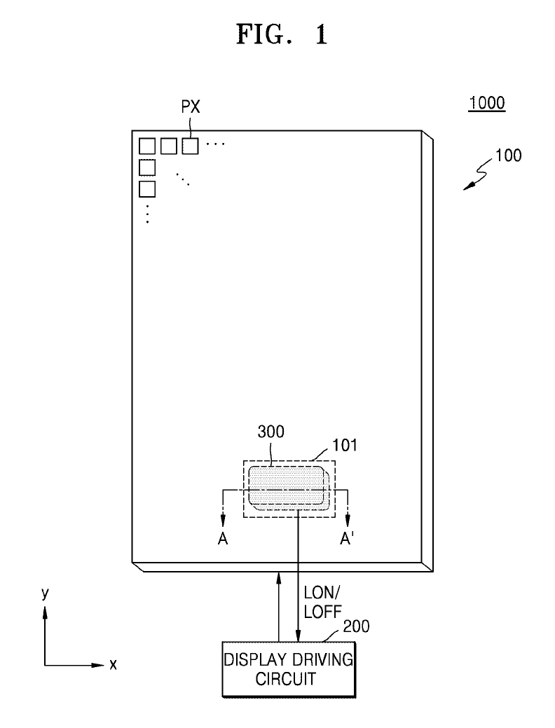

FIG. 1 illustrates a display device 1000 according to an example embodiment.

The display device 1000 according to an example embodiment may be implemented with a laptop computer, a mobile phone, a smartphone, a tablet PC, a personal digital assistant (PDA), an enterprise digital assistant (EDA), a digital still camera, a digital video camera, a portable multimedia player (PMP), a personal navigation device or portable navigation device (PND), a handheld video game console, a mobile internet device (MID), an Internet of things (IoT) device, an Internet of everything (IoE) device, a drone, an e-book reader, a wearable computing device, or the like, but is not limited thereto. In other embodiment, the display device 1000 may be one of various kinds of electronic devices having a display function and a fingerprint recognition function.

Referring to FIG. 1, the display device 1000 may include a display panel 100, a display driving circuit 200, and a fingerprint sensor 300. The fingerprint sensor 300 may be disposed under (or behind) the display panel 100. The fingerprint sensor 300 may be implemented as a semiconductor chip or a semiconductor package and may be attached on one surface of the display panel 100. The display device 1000 may further include other elements, and for example, when the display device 1000 is a mobile device, the display device 1000 may further include an application processor (“AP”).

The display panel 100 may include a plurality of pixels PX arranged in a matrix form and may display an image in units of one frame. The display panel 100 may be implemented with one of a liquid crystal display (LCD), a light-emitting diode (LED) display, an organic light-emitting diode (OLED) display, an active-matrix OLED (AMOLED) display, an electrochromic display (ECD), a digital mirror device (DMD), an actuated mirror device (AMD), a grating light value (GLV) display, a plasma display panel (PDP), an electroluminescent display (ELD), and a vacuum fluorescent display (VFD), and may be implemented with another kind of flat panel or flexible panel. Hereinafter, an example where the display panel 100 is implemented with an OLED display will be described.

In an example embodiment, the display panel 100 may further include a touch sensor (or a touch sensor layer) and/or a force sensor (or a force sensor layer). The display panel 100 including the touch sensor and/or the force sensor may be referred to as a touch screen panel. When the display panel 100 further includes the touch sensor and/or the force sensor, the display device 1000 may further include at least one circuit (e.g., a touch sensing circuit (also referred to as a touch controller) and/or a force sensing circuit) which calculates a touch input or a level of a force, based on sensing signals provided from the touch sensor and/or the force sensor.

The display driving circuit 200 may convert image data, provided from an external processor (e.g., an AP), into image signals and may provide the image signals to the display panel 100, thereby displaying an image on the display panel 100.

Moreover, when the fingerprint sensor 300 may perform a fingerprint sensing operation, the display driving circuit 200 may drive the display panel 100 so as to turn on a whole portion or a portion of a fingerprint sensing area 101 of the display panel 100. The fingerprint sensing area may denote an x-y plane of the display panel 100 where the fingerprint sensor 300 is disposed under the display panel 100. In FIG. 1, one fingerprint sensing area 101 is illustrated, but the disclosure is not limited thereto. In other embodiments, a plurality of fingerprint sensing areas may be provided on the x-y plane of the display panel 100. The fingerprint sensor 300 or a pixel array of the fingerprint sensor 300 may be disposed under the fingerprint sensing area 101. The pixels PX (e.g., OLED pixels) provided in the whole portion or the portion of the fingerprint sensing area 101 may each operate as a light source. Hereinafter, in the present example embodiment, the light source may denote each of the pixels PX provided in the entire region or the portion of the fingerprint sensing area 101. The display driving circuit 200 may turn on/off the light source provided in the entire region or the portion of the fingerprint sensing area 101.

The fingerprint sensor 300 may be an optical fingerprint sensor which senses light reflected by a ridge of a fingerprint and a valley between ridges to recognize the fingerprint. The fingerprint sensor 300 may scan the fingerprint sensing area 101, based on light provided from the display panel 100, thereby performing a fingerprint sensing operation. The fingerprint sensor 300 may generate a fingerprint image and may provide the fingerprint image to the AP. The fingerprint sensor 300 may determine whether or not an object on the fingerprint sensing area 101 is a fingerprint of a person. That is, the fingerprint sensor 300 may determine whether or not the object contacting or placed in close proximity (e.g., placed within a threshold distance) to the fingerprint sensing area 101 is a fingerprint of a person.

When the fingerprint sensor 300 performs the fingerprint sensing operation, the fingerprint sensor 300 may control the display driving circuit 200 in order for the display panel 100 to emit light from the entire region or a portion of the fingerprint sensing area 101. The fingerprint sensor 300 may transmit a light-on request signal LON or a light-off request signal LOFF to the display driving circuit 200. The fingerprint sensor 300 may transmit the light-on request signal LON and partial area information (e.g., information about a partial area, which is to be turned on, of the fingerprint sensing area 101) to the display driving circuit 200.

When fingerprint scan preparation is completed, the fingerprint sensor 300 may transmit the light-on request signal LON to the display driving circuit 200. Also, when fingerprint scan is completed, the fingerprint sensor 300 may transmit the light-off request signal LOFF to the display driving circuit 200.

In performing the fingerprint sensing operation, the pixels PX provided in the fingerprint sensing area 101 of the display panel 100 may operate as a light source which emits light having high luminance. As each of the pixels PX emits light for an extended period of time throughout its lifetime, the pixels PX may deteriorate and cause a reduction in display performance. However, in the display device 1000 according to an example embodiment, each of the pixels PX in the fingerprint sensing area 101 of the display panel 100 may emit the light only when the fingerprint sensor 300 actually scans a fingerprint, based on control by the fingerprint sensor 300, thereby minimizing a light-on time for fingerprint sensing.

In an example embodiment, the fingerprint sensor 300 may sense only a partial area of the fingerprint sensing area 101 to determine whether or not the object on (i.e., contacting or placed in close proximity to) the fingerprint sensing area 101 is a fingerprint of a person. For example, the fingerprint sensor 300 may generate a partial image by sensing the partial area of the fingerprint sensing area 101 and may determine whether the generated partial image is a fingerprint image of a person. For another example, the fingerprint sensor 300 may determine whether the object is a fingerprint of a person based on sensing signals output in at least two directions of the partial area. At this time, the display driving circuit 200 may only turn on a light source provided in the partial area of the fingerprint sensing area 101. For example, based on partial area information received from the fingerprint sensor 300 along with the light-on request signal LON, the display driving circuit 200 may turn on a light source provided in a partial portion, corresponding to the partial area information, of the fingerprint sensing area 101.

When it is determined that the object is a fingerprint of a person, the fingerprint sensor 300 may again perform the fingerprint scan operation to generate the fingerprint image (i.e., a whole fingerprint image) and may provide the generated fingerprint image to the AP. Therefore, only when a fingerprint of a person contacts (or is placed in close proximity to) the fingerprint sensing area 101, the fingerprint sensor 300 may generate the whole fingerprint image, and thus, the operation time during which the pixels PX of the fingerprint sensing area 101 are turned on may be reduced, thereby decreasing the current consumption of the fingerprint sensor 300.

Moreover, the AP may compare a pattern of the fingerprint image with a fingerprint pattern of a user to determine whether the pattern of the fingerprint image matches the fingerprint pattern of the user, and when the fingerprint image is not a fingerprint image of a person, a pattern comparison operation may be omitted, thereby decreasing the power consumption of the AP.

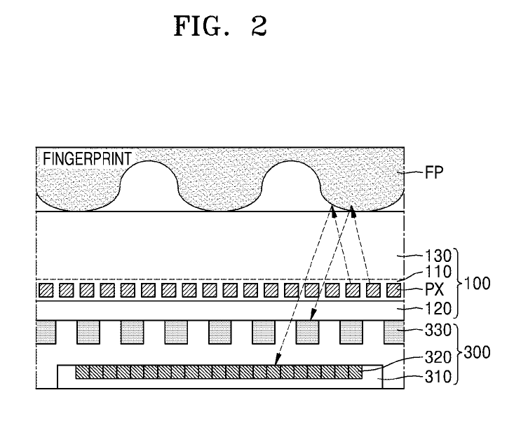

FIG. 2 illustrates an example of a vertical cross-sectional view taken along line A-A′ in the display panel and the fingerprint sensor of FIG. 1. Referring to FIG. 2, the display panel 100 may include a display layer 110 including a plurality of pixels PX (e.g., OLED pixels), a backplane 120, and a cover glass 130. The display panel 100 may further include other layers. For example, when the display panel 100 is implemented as a touch screen panel, the display panel 100 may further include a touch sensor layer including a plurality of touch sensors and/or a plurality of force sensors.

When a fingerprint FP of a user contacts or places in close proximity to the cover glass 130, light emitted from each of the plurality of pixels PX may be transferred and reflected to the fingerprint FP of the user, the reflected light may pass through the backplane 120 and may be transferred to the fingerprint sensor 300.

The fingerprint sensor 300 may be implemented as a semiconductor chip or a semiconductor package and may be attached on one surface (e.g., a bottom of the display panel 100) of the display panel 100. The fingerprint sensor 300 may include a pixel array 310 and a readout circuit 320.

The pixel array 310 may include a plurality of sensing pixels, and the plurality of sensing pixels may each include an optical-to-electric conversion device (e.g., a photodiode, a phototransistor, a photogate, a pinned photodiode, etc.). Each of the plurality of sensing pixels may sense a light reflected by each of different regions of a fingerprint and may generate an electrical signal corresponding to the sensed light. Each of the sensing pixels may generate an electrical signal corresponding to light reflected from a ridge of the fingerprint or a valley between ridges of the fingerprint. The amount of light sensed by each sensing pixel may vary depending on a pattern of a fingerprint from which light is reflected, and electrical signals having different levels may be generated based on the amount of the sensed light.

The readout circuit 320 may receive electrical signals (i.e., analog sensing signals) provided from the plurality of sensing pixels and may generate a fingerprint image by performing a processing operation on the electrical signals.

The pixel array 310 and the readout circuit 320 may be provided on different separate wafers (or semiconductor substrates), and in this case, the pixel array 310 and the readout circuit 320 may be classified as separate chips. In an example embodiment, a semiconductor chip where the pixel array 310 is implemented may be stacked on a semiconductor chip where the readout circuit 320 is implemented. Alternatively, as another example, the pixel array 310 and the readout circuit 320 may be implemented in one semiconductor chip.

The fingerprint sensor 300 may further include a light collector 330. Light, which passes through the backplane 120 of the display panel 100 and is reflected, may pass through the light collector 330 and be incident on the pixel array 310. The light collecting unit 330 may include a pin hole mask, including a plurality of pin holes, and a ultrathin lens.

In an example embodiment, the light collector 330 may be stacked on the pixel array 310, and in a process of implementing the pixel array 310, the light collector 330 may be stacked on one or more layers configuring the pixel array 310 in a layer type. In other words, the light collector 330 and the pixel array 310 may be provided as one body.

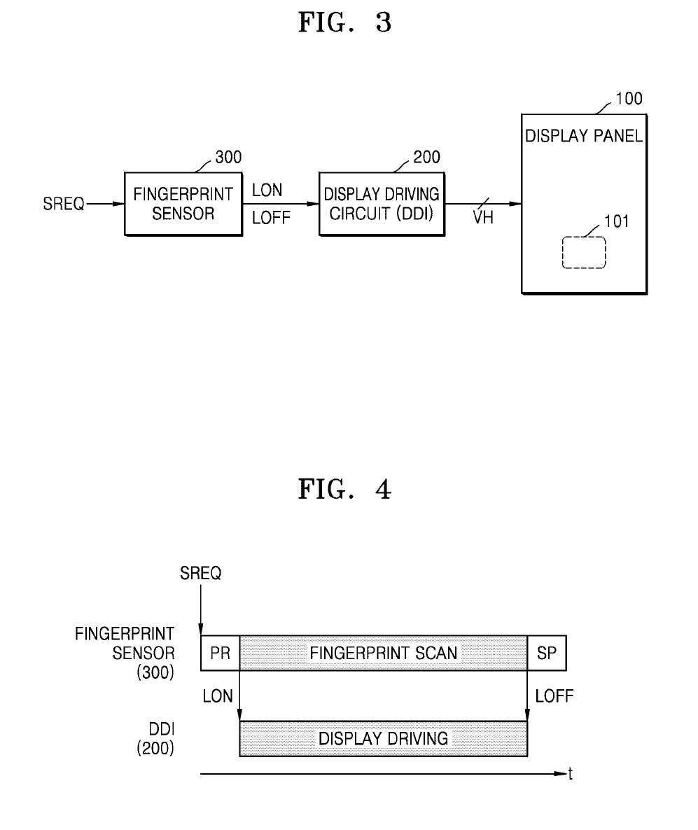

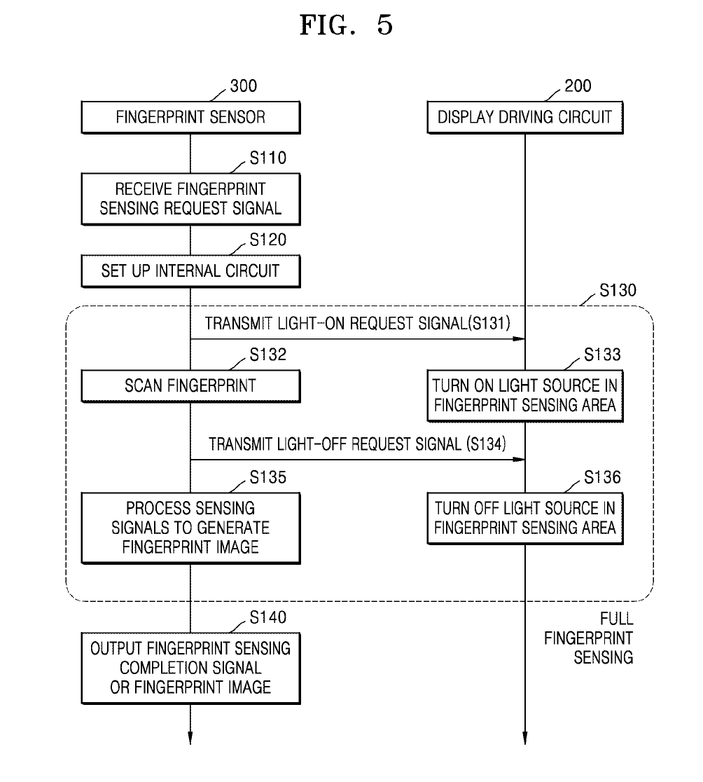

FIG. 3 is a diagram for describing an operation of each of a fingerprint sensor 300 and a display driving circuit 200 according to an example embodiment, and FIG. 4 is a diagram illustrating an operation of each of the fingerprint sensor 300 and the display driving circuit 200 of FIG. 3 with respect to time.

Referring to FIGS. 3 and 4, the fingerprint sensor 300 may receive a fingerprint sensing request signal SREQ from the outside (e.g., an external device) and may prepare for fingerprint scan. The fingerprint sensor 300 may perform a setup in order for an internal circuit to correctly perform a fingerprint sensing operation before fingerprint scan, for example, during a preparation period PR. When the fingerprint scan preparation is completed, the fingerprint sensor 300 may transmit a light-on request signal LON to the display driving circuit 200. The display driving circuit 200 may drive a display panel 100 in response to the light-on request signal LON. The display driving circuit 200 may provide a signal VH having a high gray level to light sources provided in an entire region or a portion of a fingerprint sensing area 101, thereby allowing the light sources to emit lights having high luminance.

At this time, the fingerprint sensor 300 may perform a fingerprint scan operation. The fingerprint sensor 300 may receive electrical signals, that is, analog sensing signals, provided from a plurality of sensing pixels corresponding to a whole portion or a portion of the fingerprint sensing area 101. The fingerprint sensor 300 may convert the analog sensing signals into digital signals.

When the fingerprint scan operation is completed, the fingerprint sensor 300 may transmit a light-off request signal LOFF to the display driving circuit 200. In response to the light-on request signal LOFF, the display driving circuit 200 may stop driving of the display panel 100, thereby turning off the light sources.

After a fingerprint scan period (e.g., during a signal processing period SP), the fingerprint sensor 300 may convert the received analog sensing signals into the digital signals and may generate a fingerprint image or a partial image, based on the digital signals. The fingerprint sensor 300 may also analyze the frequency components of the sensing signals or the partial image.

When the light-on request signal LON and/or the light-off request signal LOFF is provided from a device (e.g., an AP) other than the fingerprint sensor 300, the light-on request signal LON and/or the light-off request signal LOFF may be transmitted to the display driving circuit 200 irrespective of a state of the fingerprint sensor 300. The display driving circuit 200 may turn on the light sources during a time period other than the time period a period when the fingerprint sensor 300 scans a fingerprint.

However, with regard to operations of the fingerprint sensor 300 and the display driving circuit 200 of a display device (e.g., the display device 1000 of FIG. 1) according to an example embodiment, in a fingerprint sensing operation, the fingerprint sensor 300 may directly control the display driving circuit 200, and thus, each of pixels PX in the fingerprint sensing area 101 of the display panel 100 may actually emit light only during a time period in which the fingerprint sensor 300 scans a fingerprint. Therefore, an unnecessary current consumption of the display device 1000 may be prevented, and a light emitting duration of each of the light sources for fingerprint sensing may be minimized.

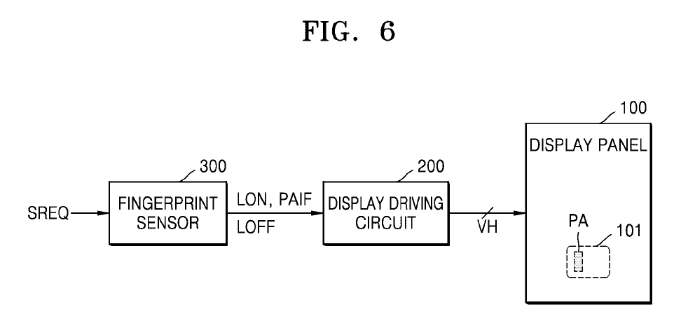

FIG. 5 is a flowchart illustrating an operation of each of a fingerprint sensor 300 and a display driving circuit 200 according to an example embodiment. FIG. 5 illustrates an example where the fingerprint sensor 300 scans the entire fingerprint sensing area.

Referring to FIG. 5, the fingerprint sensor 300 may receive a fingerprint sensing request signal in operation S110. The fingerprint sensor 300 may receive the fingerprint sensing request signal from an external processor, a touch controller, a sensor hub, or the like.

In operation S120, the fingerprint sensor 300 may set up an internal circuit. Therefore, the fingerprint sensor 300 may prepare for fingerprint scan. A bias of the internal circuit (e.g., an analog circuit) may be set.

Subsequently, full fingerprint sensing, namely, an operation of scanning the entire fingerprint sensing area, may be performed in operation S130. When the fingerprint scan preparation is completed, the fingerprint sensor 300 may transmit a light-on request signal to the display driving circuit 200 in operation S131. The display driving circuit 200 may turn on a light source in the fingerprint sensing area in response to the light-on request signal in operation S133, and when the light source is turned on, the fingerprint sensor 300 may perform the fingerprint scan operation in operation S132.

When the fingerprint scan operation is completed, the fingerprint sensor 300 may transmit a light-off request signal to the display driving circuit 200 in operation S134. The display driving circuit 200 may turn off the light source in the fingerprint sensing area in response to the light-off request signal in operation S136. After the light-off request signal is transmitted or simultaneously with transmission of the light-off request signal, the fingerprint sensor 300 may perform processing (e.g., image processing) on sensing signals to generate a fingerprint image in operation S135. In operation S140, the fingerprint sensor 300 may output a fingerprint sensing completion signal or the generated fingerprint image. For example, the fingerprint sensor 300 may transmit the fingerprint sensing completion signal or the generated fingerprint image to the AP.

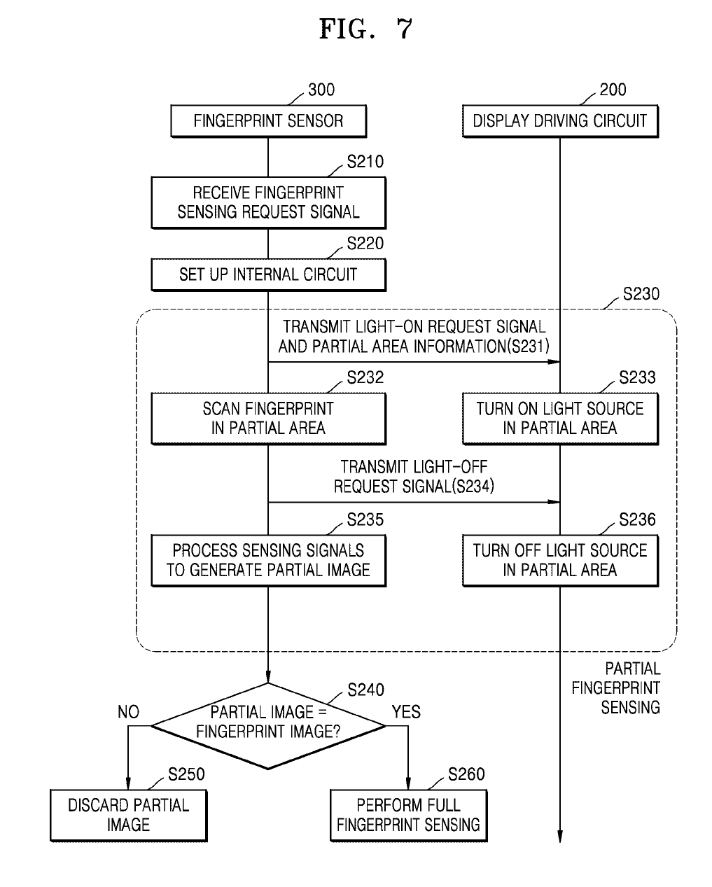

FIG. 6 is a diagram for describing an operation of each of a fingerprint sensor and a display driving circuit according to an example embodiment. FIG. 6 illustrates an operation of scanning, by a fingerprint sensor 300, a partial area of a fingerprint sensing area 101.

An operation of each of the fingerprint sensor 300 and the display driving circuit 200 of FIG. 6 is similar to the operation of each of the fingerprint sensor 300 and the display driving circuit 200 of FIG. 6. However, the fingerprint sensor 300 may transmit a light-on request signal LON and partial area information PAIF to the display driving circuit 200. The display driving circuit 200 may turn on a light source provided in a partial area PA, corresponding to the partial area information PAIF, of the fingerprint sensing area 101. The fingerprint sensor 300 may perform a fingerprint scan operation on the partial area PA instead of a whole portion of the fingerprint sensing area 101.

In an example embodiment, the partial area information PAIF may include an address of the partial area PA. Alternatively, a plurality of partial areas PA may be predetermined, and the partial area information PAIF may include an index representing one or more of the plurality of partial areas PA.

In other example embodiments, the plurality of partial areas PA may be predetermined, and whenever a light-on request signal LON is transmitted to the display driving circuit 200, one partial area may be selected from among the plurality of partial areas PA according to a predetermined order.

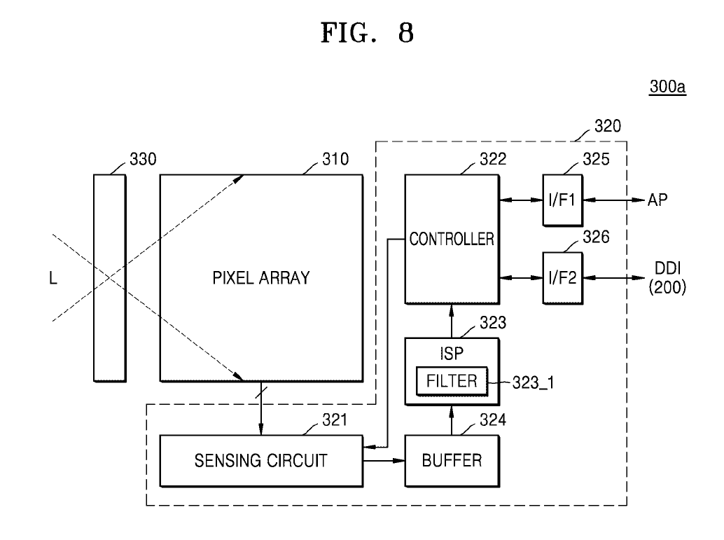

FIG. 7 is a flowchart illustrating an operation of each of a fingerprint sensor 300 and a display driving circuit 200 according to an example embodiment. FIG. 7 illustrates an example where the fingerprint sensor 300 scans a partial area (e.g., a partial area PA of FIG. 6) of a fingerprint sensing area.

Referring to FIG. 7, the fingerprint sensor 300 may receive a fingerprint sensing request signal in operation S210 and may set up other circuits in operation S220. Operations S210 and S220 are similar to operations S110 and S120 of FIG. 5.

Subsequently, partial fingerprint sensing, namely, an operation of scanning a partial area of a fingerprint sensing area, may be performed in operation S230. When fingerprint scan preparation is completed, the fingerprint sensor 300 may transmit a light-on request signal and partial area information to the display driving circuit 200 in operation S231. The display driving circuit 200 may turn on a light source provided in a partial area, corresponding to partial area information, of the fingerprint sensing area in response to the light-on request signal in operation S233, and when the light source in the partial area is turned on, the fingerprint sensor 300 may perform a fingerprint scan operation on the partial area in operation S232.

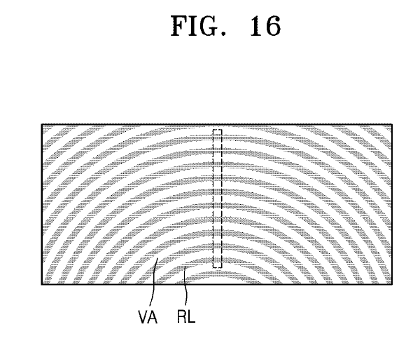

When the fingerprint scan operation is completed, the fingerprint sensor 300 may transmit a light-off request signal to the display driving circuit 200 in operation S234. The display driving circuit 200 may turn off a light source provided in the partial area in response to the light-off request signal in operation S236. After the light-off request signal is transmitted or simultaneously with transmission of the light-off request signal, the fingerprint sensor 300 may perform processing (e.g., image processing) on sensing signals to generate a partial image in operation S235. In operation S240, the fingerprint sensor 300 may determine whether the partial image is a fingerprint image. For example, the fingerprint sensor 300 may determine whether the partial image is the fingerprint image, based on a frequency component of the signals extracted from two or more directions of the partial image. That is, the fingerprint sensor 300 may determine whether the object on the fingerprint sensing area is a fingerprint of a person. As another example, the fingerprint sensor 300 may determine whether the object on the fingerprint sensing area is a fingerprint of a person, based on a frequency component of sensing signals in two more directions. This will be further described in detail with reference to FIGS. 16 to 23.

When it is determined that the partial image is the fingerprint image, the fingerprint sensor 300 may perform full fingerprint sensing for obtaining a full fingerprint image in operation S260. That is, if the fingerprint sensor 300 determines that the object is a fingerprint of a person, the fingerprint sensor 300 may perform full fingerprint sensing. The full fingerprint sensing may be performed according to operation S130 of FIG. 5. The fingerprint sensor 300 may obtain the fingerprint image and may transmit the obtained fingerprint image to a processor.

When it is determined that the partial image is not the fingerprint image, the fingerprint sensor 300 may discard the partial image in operation S250.

Therefore, the fingerprint sensor 300 may first scan the partial area of the fingerprint sensing area to determine whether an object contacting the fingerprint sensing area is a fingerprint of a person, and then, only when it is determined that the object is a fingerprint of the person, the fingerprint sensor 300 may scan the entire fingerprint sensing area to obtain a fingerprint image and may provide the fingerprint image to an AP for matching of a fingerprint pattern.

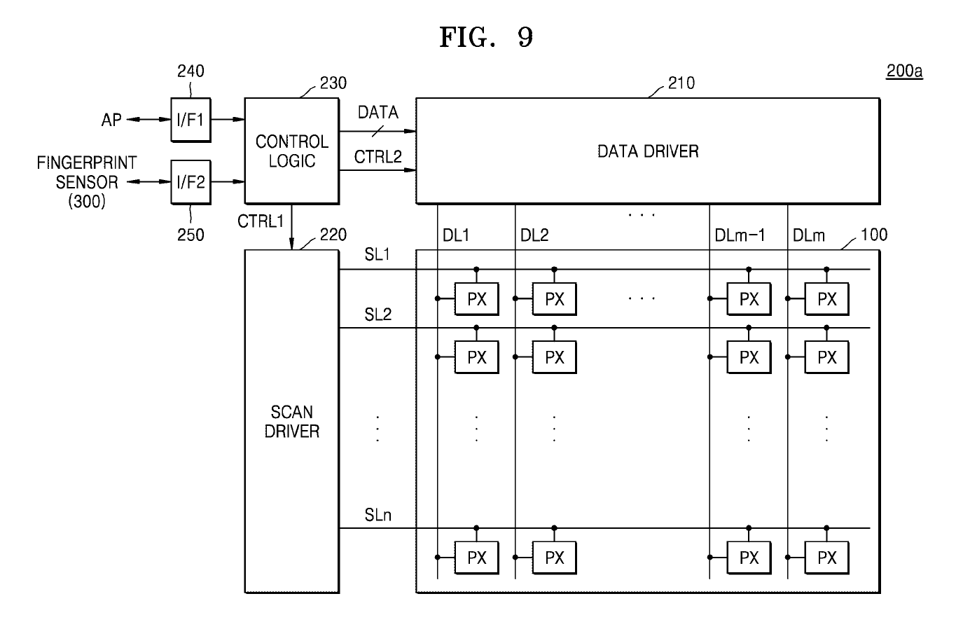

FIG. 8 illustrates an implementation example of a fingerprint sensor 300a according to an example embodiment.

Referring to FIG. 8, the fingerprint sensor 300a may include a pixel array 310, a readout circuit 320, and a light collecting unit 330. The descriptions of the pixel array 310, the readout circuit 320, and the light collecting unit 330 with reference to FIG. 2 may be applied to the pixel array 310, the readout circuit 320, and the light collecting unit 330 according to the present example embodiment.

The light collecting unit 330 may collect or receive reflection light L reflected by an object, for example, a fingerprint of a person. The reflection light L may pass through the light collecting unit 330 and may be incident on the pixel array 310. The light collecting unit 330 may include a pin hole mask, including a plurality of pin holes, and a ultrathin lens.

The pixel array 310 may include a plurality of sensing pixels, and each of the plurality of sensing pixels may sense the reflection light L to generate an electrical signal (i.e., an analog sensing signal) corresponding to the sensed light.

The readout circuit 320 may receive analog sensing signals provided from the sensing pixels of the pixel array 310 and may generate a fingerprint image or a partial image by performing a processing operation on the analog sensing signals.

The readout circuit 320 may include a sensing circuit 321, a controller 322, a signal processor 323, a buffer 324, a first interface 325, and a second interface 326.

The sensing circuit 321 may receive the analog sensing signals from the pixel array 310 and may convert the received analog sensing signals into digital sensing signals. The sensing circuit 321 may include a plurality of analog-to-digital converters (ADCs), and each of the ADCs may convert an analog sensing signal, provided from a corresponding channel of channels connected to the pixel array 310, into a digital sensing signal. The digital sensing signal may be provided to the signal processor 323, or may be temporarily stored in the buffer 324 and then may be provided to the signal processor 323.

The buffer 324 may temporarily store the digital sensing signal provided from the sensing circuit 321. The buffer 324 may store various kinds of settings values, algorithms, etc. set for an operation of the fingerprint sensor 300a. The buffer 324 may be implemented with at least one of a volatile memory or a nonvolatile memory. Examples of the nonvolatile memory may include read-only memory (ROM), programmable ROM (PROM), electrically programmable ROM (EPROM), electrically erasable and programmable ROM (EEPROM), flash memory, phase-change random access memory (PRAM), magnetic RAM (MRAM), resistive RAM (RRAM), ferroelectric RAM (FRAM), etc. Examples of the volatile memory may include dynamic RAM (DRAM), static RAM (SRAM), synchronous DRAM (SDRAM), phase-change RAM (PRAM), magnetic RAM (MRAM), resistive RAM (RRAM), ferroelectric RAM (FeRAM), etc.

The signal processor 323 may generate a fingerprint image or a partial image, based on the sensing signals. The signal processor 323 may analyze frequency components of the sensing signals. The sensing signals may be included in the partial image generated by the signal processor 323. For example, the signal processor 323 may extract a signal having a certain frequency band from among the sensing signals. To this end, the signal processor 323 may include a frequency analysis filter 323_1.

The frequency analysis filter 323_1 may include, for example, a fast Fourier transform (FFT) filter, a digital infinite impulse response (IIR) filter, a band pass filter, and/or the like. However, the present example embodiment is not limited thereto, and in other embodiments, the frequency analysis filter 323_1 may include various other types of filters.

The controller 322 may control an overall operation of the fingerprint sensor 300a. The controller 322 may control a driving timing of the sensing circuit 321. Also, the controller 322 may transmit a light-on request signal and/or a light-off request signal to the display driving circuit 200 through the second interface 326. In an example embodiment, the fingerprint sensor 300a may operate in synchronization with the display driving circuit 200, and the controller 322 may transmit a synchronization signal (e.g., a vertical synchronization signal and/or a horizontal synchronization signal) to the display driving circuit 200 through the second interface 326, or may receive the synchronization signal from the display driving circuit 200.

When the fingerprint sensor 300a performs a full fingerprint sensing operation, the controller 322 may transmit the fingerprint image, provided from the signal processor 323, to the AP through the first interface 325.

When the fingerprint sensor 300a performs a partial fingerprint sensing operation, the controller 322 may determine whether the object is a fingerprint of a person, based on a frequency component of the sensing signals provided from the signal processor 323. In an example embodiment, the controller 322 may determine whether the partial image is a fingerprint image. The controller 322 may perform control in order for the fingerprint sensor 300a to perform the full fingerprint sensing operation. In an example embodiment, when it is determined that the partial image is not a fingerprint image, the controller 322 may discard the partial image.

The first interface 325 may be a communication circuit which enables the fingerprint sensor 300a to communicate with an external processor (e.g., the AP), and the second interface 326 may be a communication circuit which enables the fingerprint sensor 300a to communicate with the display driving circuit 200. In an example embodiment, the first interface 325 and the second interface 326 may be implemented as one circuit.

The first interface 325 and the second interface 326 may be the same interfaces or different interfaces. Each of the first interface 325 and the second interface 326 may include one of an RGB interface, a central processing unit (CPU) interface, a serial interface, a mobile display digital interface (MDDI), an inter integrated circuit (I2C) interface, a serial peripheral interface (SPI), a micro controller unit (MCU) interface, a mobile industry processor interface (MIPI), an embedded display port (eDP) interface, a D-subminiature (D-sub) interface, an optical interface, and a High-Definition Multimedia Interface (HDMI). Additionally or alternatively, each of the first interface 325 and the second interface 326 may include, for example, a mobile high-definition link (MHL) interface, a secure digital (SD) card/multimedia card (MMC) interface, or an infrared data association (IrDA) standard interface. In addition, each of the first interface 325 and the second interface 326 may include one of various serial or parallel interfaces.

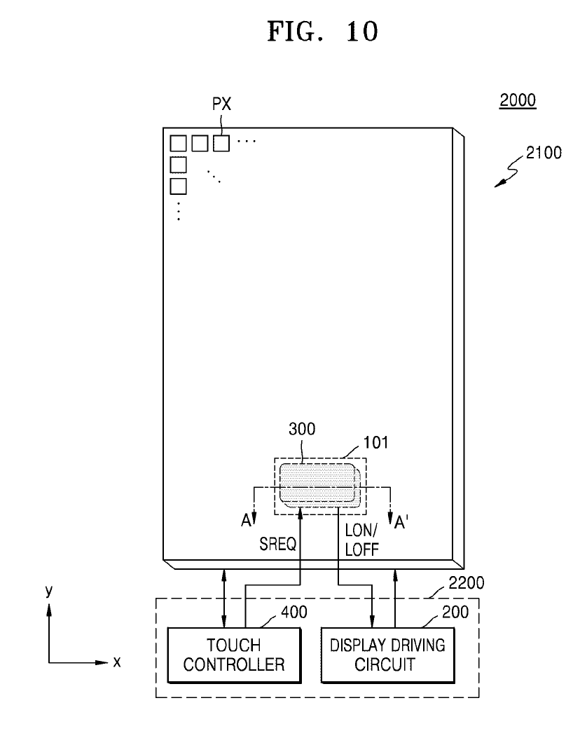

FIG. 9 illustrates an implementation of a display driving circuit 200a according to an example embodiment. For convenience of description, a display panel 100 is also illustrated.

Referring to FIG. 9, the display driving circuit 200a may include a data driver 210, a scan driver 220, a control logic 230, a first interface 240, and a second interface 250. In addition, the display driving circuit 200a may further include a voltage generation circuit and an image signal processing circuit.

In response to a first control signal CTRL1 provided from the control logic 230, the scan driver 220 may provide an on signal to a plurality of scan lines SL1 to SLn included in the display panel 100 to select the scan lines SL1 to SLn. In a display operation, the scan driver 220 may sequentially select the scan lines SL1 to SLn of the display panel 100. In a fingerprint sensing operation, the scan driver 220 may sequentially or simultaneously select some (e.g., scan lines corresponding to an emissive area) of the scan lines SL1 to SLn of the display panel 100.

In response to a second control signal CTRL2, the data driver 210 may convert image data DATA into image signals (e.g., a grayscale voltage corresponding to each pixel data of the image data DATA) which are analog signals, and may provide the image signals to a plurality of data lines DL1 to DLm. When each of a plurality of pixels PX operates as a light source for a fingerprint sensing operation, the data driver 210 may provide image signals representing a highest gray level to some (e.g., lines corresponding to the emissive area) of the data lines DL1 to DLm.

The control logic 230 may control an overall operation of the display driving circuit 200a. The control logic 230 may control a driving timing of each of the data driver 210 and the scan driver 220 and may be referred to as a timing controller. The control logic 230 may receive image data and control signals (e.g., a vertical synchronization signal, a horizontal synchronization signal, a clock signal, etc.) provided to an external processor (e.g., an AP) through the first interface 240 and may generate the first control signal CTRL1 for controlling the scan driver 220 and the second control signal CTRL2 for controlling the data driver 210, based on the received control signals. Also, the control logic 230 may convert a format of image data so as to match an interface specification suitable for the data driver 210 and may transmit image data DATA, obtained through the conversion, to the data driver 210.

The control logic 230 may receive a light-on request signal and a light-off request signal from the fingerprint sensor 300 through the second interface 250. In response to the light-on request signal, the control logic 230 may turn on a light source corresponding to an entire region or a portion of the fingerprint sensing area, namely, pixels PX provided in the entire region or the portion of the fingerprint sensing area, and in response to the light-off request signal, the control logic 230 may turn off a plurality of light sources.

The control logic 230 may receive the synchronization signal from the fingerprint sensor 300 through the second interface 250, or may transmit the synchronization signal to the fingerprint sensor 300. The control logic 230 may generate the first control signal CTRL1 and the second control signal CTRL2 in synchronization with the fingerprint sensor 300 and may control an operation timing of each of the data driver 210 and the scan driver 220, based on the generated first control signal CTRL1 and second control signal CTRL2. In response to the first control signal CTRL1 and the second control signal CTRL2, the data driver 210 and the scan driver 220 may operate, and thus, the light source corresponding to the whole portion or the portion of the fingerprint sensing area may be turned on or off.

The first interface 240 may be a communication circuit which enables the display driving circuit 200a to communicate with an external processor (e.g., the AP), and the second interface 250 may be a communication circuit which enables the display driving circuit 200a to communicate with the fingerprint sensor 300. In an example embodiment, the first interface 240 and the second interface 250 may be implemented as one circuit. The first interface 240 and the second interface 250 may each include one of various interfaces.

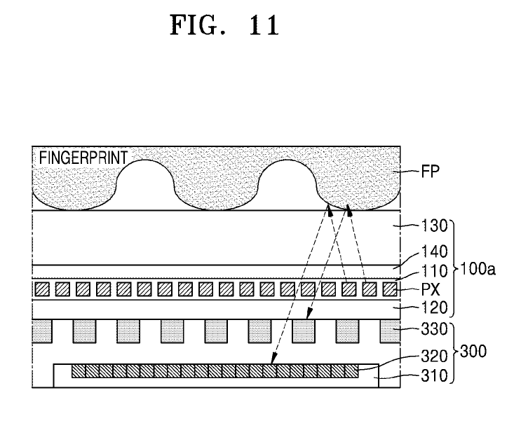

FIG. 10 illustrates a touch screen device 2000 according to an example embodiment.

The touch screen device 2000 may be one of various kinds of electronic devices having a display function, a touch recognition function, and a fingerprint recognition function. For example, the touch screen device 2000 may be one of the various electronic devices described above with reference to FIG. 1.

The touch screen device 2000 may include a touch screen panel 2100, a touch screen driving circuit 2200, and a fingerprint sensor 300. The touch screen device 2000 may further include an AP.

The touch screen panel 2100 may display an image and may sense a touch input occurring in the touch screen panel 2100. The touch input may include, for example, an object such as a finger directly contacting the touch screen panel 2100, and moreover, the object placed in close proximity to the touch screen panel 2100. The touch screen panel 2100 may include a display layer and a touch sensor layer, and the touch sensor layer may be disposed over the display layer or may be provided as one body with the display layer.

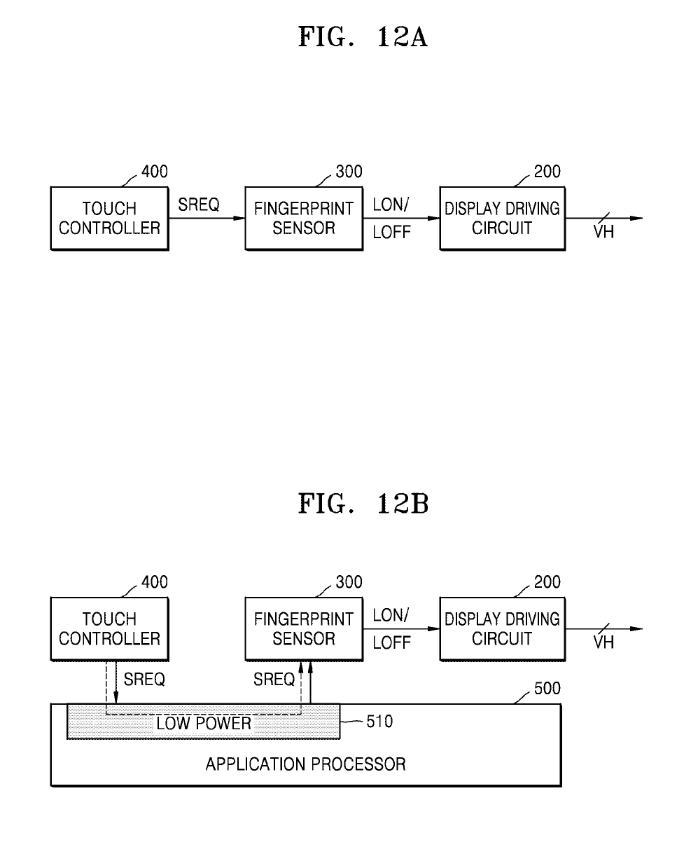

FIG. 11 illustrates an example of a vertical cross-sectional view taken along line A-A′ in the touch screen panel and the fingerprint sensor of FIG. 10. The vertical cross-sectional view of FIG. 11 is similar to the vertical cross-sectional view of FIG. 2. However, the touch screen panel 2100 may further include a touch sensor layer 140. For example, as illustrated in FIG. 11, the touch sensor layer 140 may be disposed between a display layer 110 and a cover glass 130. However, the present embodiment is not limited thereto, and in other embodiments, the touch sensor layer 140 may be provided as one body with a plurality of pixels PX.

A touch sensor may be provided in the touch sensor layer 140 and may include a plurality of touch sensing units arranged in a matrix form. The touch sensor may sense a touch input applied to the touch screen panel 2100 to generate a sensing signal, for example, a touch sensing signal. The touch sensor may provide the touch sensing signal to a touch controller 400.

The touch sensor may be implemented with a capacitive sensor. The touch sensor 20 may include a plurality of touch sensing units which are arranged in a matrix form on an x-y plane. The touch sensing units may each be implemented with a sensor electrode disposed in the touch sensor layer 140. The sensor electrode may include a transparent conductive material such as indium tin oxide (ITO), indium zinc oxide (IZO) or indium zinc tin oxide (IZTO). However, the present example embodiment is not limited thereto, and in other embodiments, the touch sensor may be implemented with various other types of sensors such as a resistive overlay type, a surface acoustic wave type, an infrared type, a surface elastic wave type, an inductive type, etc.

In an example embodiment, the touch screen panel 2100 may sense a force of a touch input occurring in the touch screen panel 2100. The touch screen panel 2100 may further include a force sensor. The force sensor may include a plurality of force sensing units arranged in a matrix form, and the force sensing units may each be implemented with a plurality of force sensing electrodes arranged in a matrix form or arranged in a column and row. In an example embodiment, the touch force and the force sensor may share a sensing electrode.

Referring to FIG. 11, the touch screen driving circuit 2200 may include a display driving circuit 200 and a touch controller 400. The display driving circuit 200 and the touch controller 400 may be provided in separate semiconductor chips. Alternatively, the display driving circuit 200 and the touch controller 400 may be integrated into one semiconductor chip.

The display driving circuit 200 may display an image on the touch screen panel 2100, namely, the display layer 110 of the touch screen panel 2100, and in a fingerprint sensing operation, the fingerprint sensor 300 may turn on a light source provided in a fingerprint sensing area 101. The operation of the display driving circuit 200 described above with reference to FIG. 1 may be applied to the display driving circuit 200 according to an example embodiment. A repetitive description is omitted.

The touch controller 400 may provide a driving signal to the touch sensor layer 140 and may process a sensing signal received from the touch sensor layer 140 to determine whether a touch input occurs and to calculate touch coordinates, based on the driving signal.

The touch screen device 2000 may operate in a low power mode, but in a case where the touch screen device 2000 is set to perform the touch sensing function (e.g., always-on touch mode) in the low power mode, when a touch input or a touch force having a threshold level or more occurs in the touch screen panel, the touch controller 400 may indirectly or directly provide a fingerprint sensing request signal SREQ.

In response to the fingerprint sensing request signal SREQ provided from the touch controller 400, the fingerprint sensor 300 may switch from the low power mode (e.g., a sleep mode) to an operation mode (e.g., a normal operation mode) and may perform a fingerprint sensing operation.

After fingerprint scan preparation is completed, the fingerprint sensor 300 may transmit a light-on request signal LON to the display driving circuit 200, and then, when fingerprint scan is completed, the fingerprint sensor 300 may transmit a light-off request signal LOFF to the display driving circuit 200.

Operations of the fingerprint sensor 300 and the display driving circuit 200 are as described above with reference to FIG. 1, and thus, repetitive descriptions are omitted.

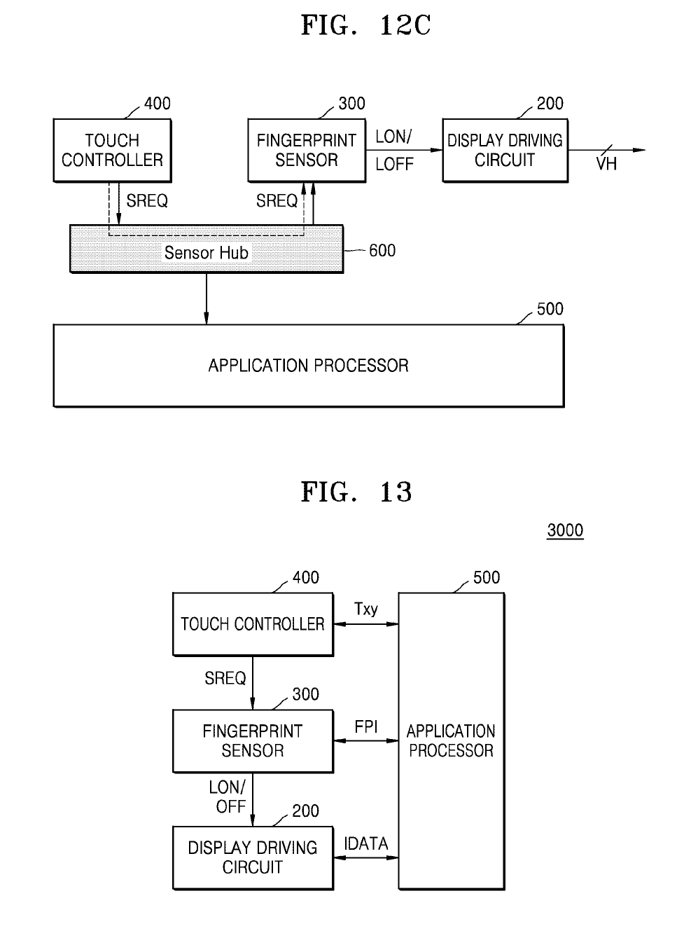

FIGS. 12A, 12B, and 12C are diagrams for describing a method of receiving, by a fingerprint sensor 300, a fingerprint sensing request signal SREQ from a touch controller 400.

Referring to FIG. 12A, the fingerprint sensor 300 may directly receive the fingerprint sensing request signal SREQ from the touch controller 400. The fingerprint sensor 300 and the touch controller 400 may each include an interface for direct communication therebetween.

Referring to FIGS. 12B and 12C, the fingerprint sensor 300 may indirectly receive the fingerprint sensing request signal SREQ from the touch controller 400.

Referring to FIG. 12B, each of the fingerprint sensor 300 and the touch controller 400 may communicate with an external processor, for example, an AP 500. The touch controller 400 may transmit the fingerprint sensing request signal SREQ to the fingerprint sensor 300 through the AP 500. When a touch screen device (2000 of FIG. 10) operates in the low power mode, the AP 500 may be in a sleep state (or a low power state). The AP 500 may include a low power area 510, and when the AP 500 is in the sleep state, the low power area 510 may perform a full operation or a partial operation. The low power area 510 may provide the fingerprint sensing request signal SREQ, received from the touch controller 400, to the fingerprint sensor 300.

Referring to FIG. 12C, the fingerprint sensor 300 and the touch controller 400 may be connected to a sensor hub 600 and may communicate with the AP 500 through the sensor hub 600.

The sensor hub 600 may be connected between various sensors and the AP 500. The sensor hub 600 may provide data, information, and notifications received from the various sensors to the AP 500 and may transmit a control signal, provided from the AP 500, to the sensors.

In FIG. 12C, the sensor hub 600 may provide touch coordinates provided from the touch controller 400 and a fingerprint image provided from the fingerprint sensor 300 to the AP 500. The touch controller 400 may transmit the fingerprint sensing request signal SREQ to the fingerprint sensor 300 through the sensor hub 600.

In FIG. 12C, the sensor hub 600 and the AP 500 are illustrated as separate elements, but are not limited thereto. In other embodiments, the sensor hub 600 may be included in the AP 500.

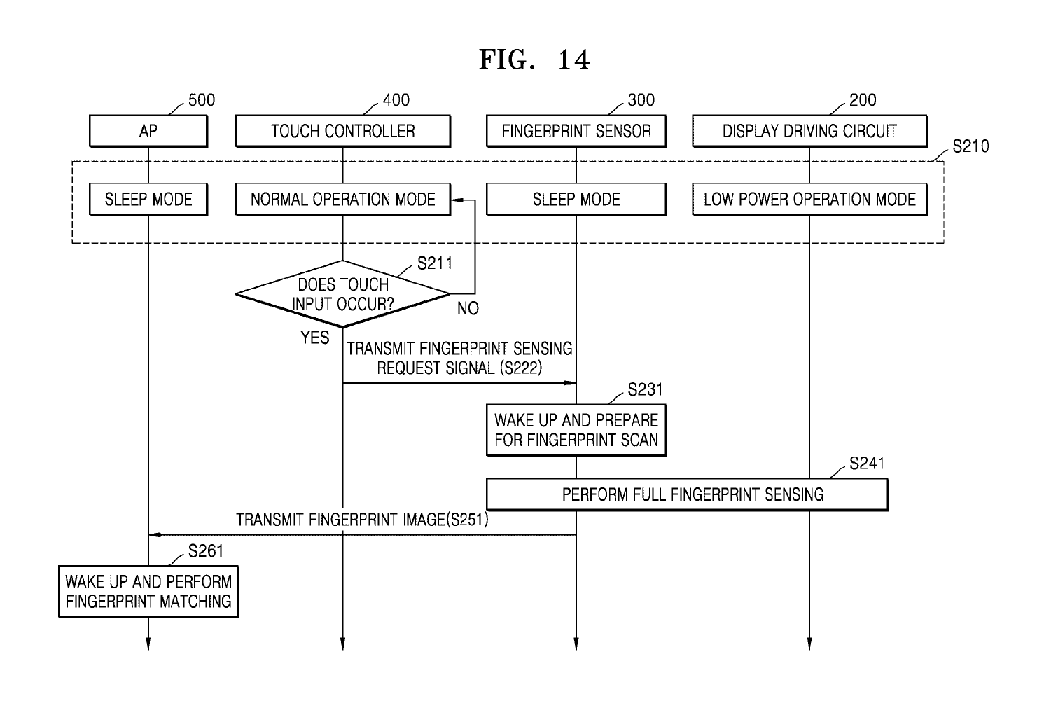

FIG. 13 is a block diagram illustrating a mobile device 3000 according to an embodiment. The mobile device 3000 may be implemented with the touch screen device of FIG. 10 and may include a touch screen panel.

The mobile device 3000 may include a display driving circuit 200, a fingerprint sensor 300, a touch controller 400, and an AP 500. The touch screen panel may be omitted. Descriptions of the display driving circuit 200, the fingerprint sensor 300, the touch controller 400, and the AP 500 made with reference to FIGS. 1 to 12C may be applied to the present example embodiment.

The AP 500 may control an overall operation of the mobile device 3000. The AP 500 may communicate with the display driving circuit 200, the fingerprint sensor 300, and the touch controller 400 and may control the display driving circuit 200, the fingerprint sensor 300, and the touch controller 400.

In detail, in performing a display operation, the AP 500 may provide image data IDATA to the display driving circuit 200. In performing a touch sensing operation, the AP 500 may control the mobile device 3000 to perform an operation desired by a user, based on touch coordinates Txy provided from the touch controller 400. For example, if a user interface displayed on the touch screen panel includes icons corresponding to various kinds of applications, the AP 500 may execute a program or an application corresponding to an icon corresponding to the touch coordinates Txy.

In performing the touch sensing operation, the AP 500 may receive a fingerprint image FPI provided from the fingerprint sensor 300 and may perform user authentication, based on the fingerprint image FPI. For example, the AP 500 may obtain a fingerprint pattern from the fingerprint image FPI and may compare the obtained fingerprint pattern with a predetermined pattern of a user fingerprint to determine whether there is a match therebetween. When the fingerprint patterns match each other, the AP 500 may determine that the user authentication was successful, and may perform various operations based on the user authentication.

For example, in a case where the mobile device is in a locked state, if user authentication succeeds, the AP 500 may change the mobile device to an unlocked state. Alternatively, when an authenticated user desires to use security data (e.g., encrypted data), the AP 500 may access the security data, or may perform a processing operation on the security data.

The AP 500 may include a trusted zone for processing the security data (e.g., sensitive data), and the fingerprint image FPI may be received in the trusted zone. The AP 500 may include a rich execution environment (REE) and a trusted execution environment (TEE), and a trusted environment may be applied to the trusted zone. The trusted zone and other zones (e.g., general zones) may be implemented as a physically separated type, a software separated type, or a combination type of physical separation and software separation.

In performing the fingerprint sensing operation, the fingerprint sensor 300 may control the display driving circuit 200. The fingerprint sensor 300 may transmit a light-on request signal LON and/or a light-off request signal LOFF to the display driving circuit 200. In response to the light-on request signal LON and/or the light-off request signal LOFF received from the fingerprint sensor 300, the display driving circuit 200 may turn on or off light sources provided in a whole portion or a portion of a fingerprint sensing area 101 of a touch screen panel (2100 of FIG. 10).

The fingerprint sensor 300 may receive a fingerprint sensing command from the AP 500, and in response to the fingerprint sensing command, the fingerprint sensor 300 may operate. When the fingerprint sensing operation is completed, the fingerprint sensor 300 may provide a fingerprint sensing completion signal and the fingerprint image FPI to the AP 500.

When the mobile device 3000 operates in the low power mode, the AP 500 may be in the sleep mode (or the low power mode). The AP 500 may stop an operation, or only a partial area of the AP 500 may operate.

At this time, when a touch input is sensed through the touch screen panel, the touch controller 400 may control the fingerprint sensor 300 to perform the fingerprint sensing operation. The touch controller 400 may sense the touch input occurring in the touch screen panel and may provide a fingerprint sensing request signal SREQ to the fingerprint sensor 300. In FIG. 13, it is illustrated that the touch controller 400 directly provides the fingerprint sensing request signal SREQ to the fingerprint sensor 300, but the present example embodiment is not limited thereto. As described with reference to FIGS. 12B and 12C, the touch controller 400 may indirectly provide the fingerprint sensing request signal SREQ to the fingerprint sensor 300 (e.g., via an intervening device or component).

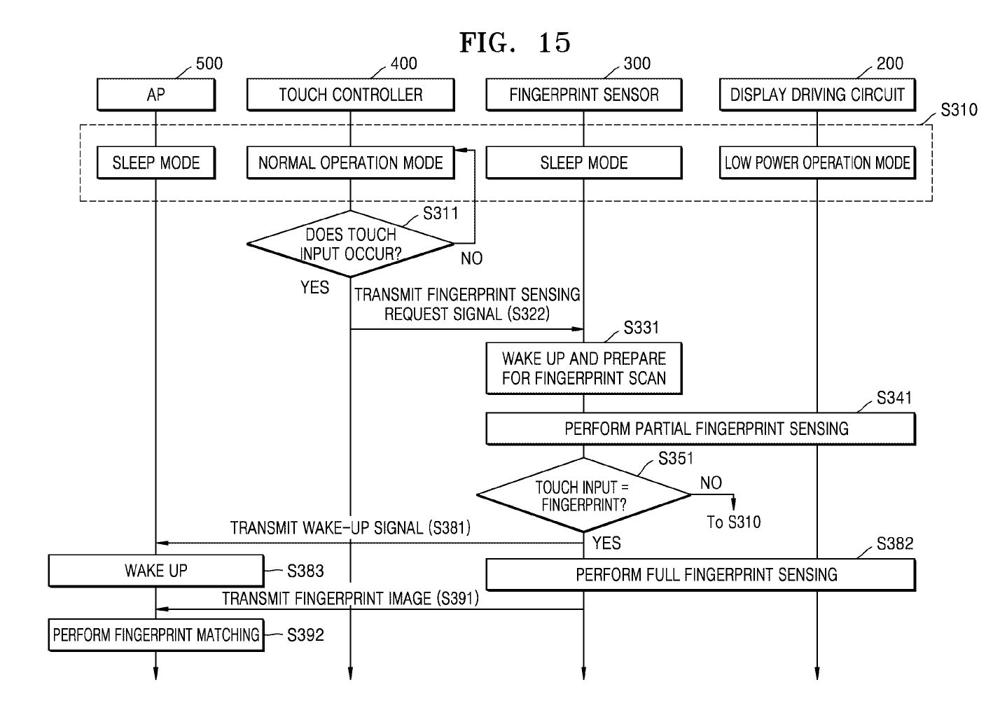

FIGS. 14 and 15 are flowcharts illustrating an operation of each of elements of the mobile device 3000 of FIG. 13.

An example where the mobile device 3000 operates in the low power mode in a locked state will be described below.

Referring to FIG. 14, in operation S210 where the mobile device 3000 operates in the low power mode, the AP 500 and the fingerprint sensor 300 may operate in the sleep mode (or the low power mode), the touch controller 400 may operate in an operation mode, and the display driving circuit 200 may operate in a low power operation mode. For example, the display driving circuit 200 may display an image on only a partial area of the touch screen panel. The low power mode may be referred to as an always-on display (AOD) mode or an always-on touch (AOT) mode. In an embodiment, the touch controller 400 may operate in the low power operation mode and may sense a touch input which occurs in the partial area or another partial area of the touch screen panel.

In operation S211, the touch controller 400 may perform touch sensing continuously (e.g., at predetermined time intervals) to determine whether a touch input has occurred.

When the touch input occurs on the touch screen panel, the touch controller 400 may transmit a fingerprint sensing request signal to the fingerprint sensor 300 in operation S222. In a case where the mobile device 3000 is in a locked state, even if the touch input occurs, only when user authentication should be performed, the mobile device 3000 may be changed from the low power mode to a normal operation mode. Therefore, the touch controller 400 may transmit the fingerprint sensing request signal to the fingerprint sensor 300, for the user authentication.

In response to the fingerprint sensing request signal, the fingerprint sensor 300 may be woken up and may prepare for fingerprint scan in operation S231. In other words, the fingerprint sensor 300 may be changed to the operation mode and may prepare for the fingerprint sensing operation. The fingerprint sensor 300 may be set in order for an internal circuit to normally operate.

When the fingerprint scan preparation is completed, the fingerprint sensor 300 and the display driving circuit 200 may perform full fingerprint sensing in operation S241. As described above with reference to operation S130 of FIG. 5, the full fingerprint sensing may be performed. The fingerprint sensor 300 may scan an entire fingerprint sensing area to generate a fingerprint image and may transmit the fingerprint image to the AP 500 in operation S251.

When the fingerprint image is received, the AP 500 may be changed from the sleep mode (or the low power mode) to the operation mode and may perform a fingerprint matching operation in operation S261. When a pattern of the received fingerprint image matches a predetermined pattern of a user fingerprint, the mobile device 3000 may be changed to the operation mode.

Referring to FIG. 15, in operation S310 where the mobile device 3000 operates in the low power mode, the AP 500 and the fingerprint sensor 300 may operate in the sleep mode (or the low power mode), the touch controller 400 may operate in the operation mode, and the display driving circuit 200 may operate in the low power operation mode. The display driving circuit 200 may display an image on only a partial area of the touch screen panel. In an example embodiment, the partial area includes a fingerprint sensing area (e.g., the fingerprint sensing area 101 of FIG. 10) of the touch screen panel. In an example embodiment, the touch controller 400 may also operate in the low power operation mode and may sense a touch input which occurs in the partial area or another partial area of the touch screen panel.

In operation S311, the touch controller 400 may perform touch sensing continuously (e.g., at predetermined time intervals) to determine whether a touch input has occurred. When the touch input occurs, the touch controller 400 may transmit a fingerprint sensing request signal to the fingerprint sensor 300 in operation S322.

In response to the fingerprint sensing request signal, the fingerprint sensor 300 may be changed from the sleep mode to the operation mode and may prepare for fingerprint scan in operation S331.

When the fingerprint scan preparation is completed, the fingerprint sensor 300 and the display driving circuit 200 may perform partial fingerprint sensing in operation S341. As described above with reference to operation S230 of FIG. 7, the partial fingerprint sensing may be performed. The fingerprint sensor 300 may scan a partial area of a fingerprint sensing area to generate a partial image or sensing signals.

The fingerprint sensor 300 may determine whether the touch input (i.e., an object on the fingerprint sensing area) is a fingerprint of a person in operation S351. For example, the fingerprint sensor 300 may determine whether the touch input is a fingerprint of a person, based on a partial image or sensing signals. For example, the fingerprint sensor 300 may analyze frequency components of the sensing signals or two or more sensing signals provided in the partial image, and may determine whether the touch input is a fingerprint of a person, based on the frequency components.

When it is determined that the touch input is not a fingerprint of a person, the mobile device 3000 may continuously operate in the low power mode. In an example embodiment, the fingerprint sensor 300 may discard the partial image

When it is determined that the touch input is a fingerprint of a person, the fingerprint sensor 300 may transmit a wake-up signal to the AP 500 in operation S381. Therefore, the AP 500 may be changed from the sleep mode (or the low power mode) to the operation mode.

Moreover, the fingerprint sensor 300 may perform full fingerprint sensing in operation S382. The fingerprint sensor 300 may obtain the fingerprint image. The fingerprint sensor 300 may transmit the fingerprint image to the AP 500 in operation S391.

The AP 500 may perform a fingerprint matching operation, based on the received fingerprint image. The AP 500 may compare a fingerprint pattern of the received fingerprint image with a predetermined fingerprint pattern of a user fingerprint. When the fingerprint patterns match each other, the AP 500 may determine that the user authentication was successful, and may change a mode of the mobile device 3000 to the operation mode.

According to an example embodiment, when a touch input occurs, without immediately obtaining a fingerprint image to perform fingerprint matching, the mobile device 3000 may determine whether the touch input is a fingerprint of a person, and when the touch input is a fingerprint of a person, the mobile device 3000 may obtain the fingerprint image and may perform fingerprint matching, based on the obtained fingerprint image. Therefore, when instead of a fingerprint of a user, another object (e.g., another body part of the user, an inanimate object, or the like) contacts a touch screen of the mobile device 3000, the AP 500 may be prevented from being changed from the sleep mode (or the low power mode) to the operation mode. Accordingly, the power consumption of the mobile device 3000 may be reduced.

Hereinafter, a method of determining, by the fingerprint sensor 300, whether an object on the fingerprint sensing area is a fingerprint of a person will be described in detail.

FIG. 16 is a diagram illustrating a portion of a fingerprint of a person.

Referring to FIG. 16, a fingerprint of a person may include a ridge RL which is a raised part and a valley VA between ridges, and a distance between two adjacent ridges RL may be between about 250 μm and 650 μm. About 1.5 to 4 ridges RL may be disposed per 1 mm (millimeter). As illustrated, when a fingerprint pattern is obtained in a direction vertical to a pattern consisting of the ridge RL and the valley VA, a spatial frequency “f” of the fingerprint pattern may be about 1.5 KHz to 4 KHz. A fingerprint sensor 300 may obtain image points at intervals of k mm (where k is a positive number), that is, a sensing circuit (e.g., the sensing circuit 321 of FIG. 8) of the fingerprint sensor 300 receives analog sensing signals at intervals of k mm, and convert the analog sensing signals into digital sensing signals, a normalized spatial frequency \hat{ƒ} of a digitized fingerprint pattern may be expressed as the following Equation 1:

\hat{ƒ}=kƒ . . . (1)

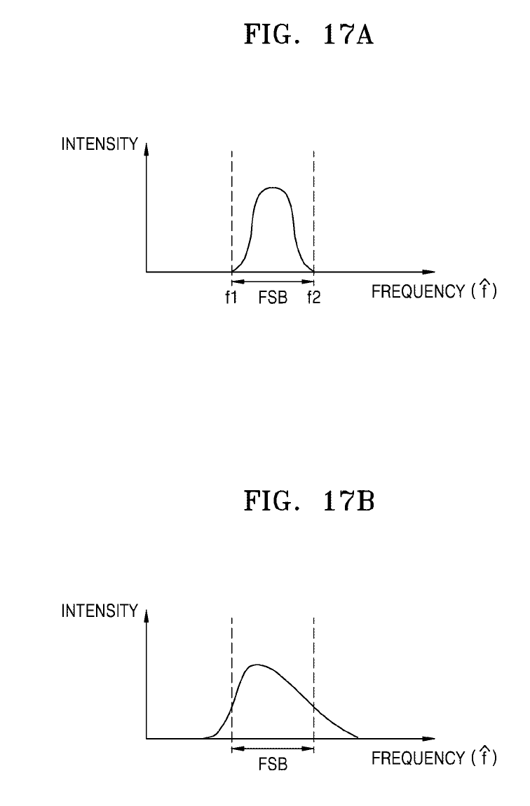

FIG. 17A is a diagram showing a signal intensity of a hypothetical fingerprint pattern on a frequency domain, and FIG. 17B is diagram showing a signal intensity of the exemplary fingerprint sensing signal on a frequency domain. In FIG. 17A and FIG. 17B, the horizontal axis represents a normalized spatial frequency \hat{ƒ} and the vertical axis represents a signal intensity.

Referring to FIG. 17A, a normalized spatial frequency of a digitized fingerprint pattern may be distributed between the first frequency f1 and the second frequency f2. For example, the first frequency f1 may be approximately k*1.5 KHz and the second frequency f2 may be approximately k*4 KHz. The frequency band between the first frequency f1 and the second frequency f2 may be referred to as a fingerprint spatial frequency band FSB.

If an object on the fingerprint sensing area, i.e., touch input, of the touch screen panel (e.g., the touch screen panel 2100 in FIG. 10) or the display panel (e.g., the display panel 100 in FIG. 1) is a fingerprint of a person, a signal intensity of the fingerprint frequency band FSB among a normalized spatial frequency of a sensing signal, i.e., a digital sensing signal, may be relatively greater than that of the other frequency bands.

Therefore, the fingerprint sensor 300 may determine whether the object is a fingerprint of the person, based on a signal intensity of the fingerprint spatial frequency band FSB among a normalized spatial frequency of a sensing signal obtained from one direction of the fingerprint sensing area 101.

For example, as shown in FIG. 17B, even if the frequency component of the sensing signal is distributed over a wide frequency band, the fingerprint sensor 300 may measure the signal intensity of the fingerprint frequency band FSB. For example, the signal processor (e.g., the signal processor 323 in FIG. 8) may measure (or extract) the signal intensity of the fingerprint frequency band FSB of the sensing signal through a Fourier transform, a bandpass filter or the like. The fingerprint sensor 300 may calculate a power of the fingerprint frequency band FSB, based on the signal intensity of the measured fingerprint frequency band FSB. When the power of the fingerprint frequency band FSB of the sensing signal corresponds to a predetermined ratio or more of a power of the entire frequency band (hereinafter, referred to as total frequency power), the fingerprint sensor 300 may determine that the sensing signal is generated by scanning the fingerprint of a person. In other words, the fingerprint sensor 300 may determine that an object on the fingerprint sensing area 101 of the touch screen panel (e.g., the touch screen panel in FIG. 10) or the display panel (e.g., the display panel 100 in FIG. 1) is a fingerprint of a person.

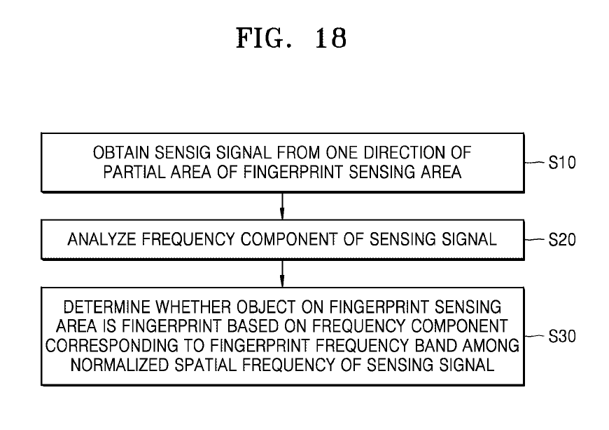

FIG. 18 is a flowchart for describing a method of determining whether an object on a fingerprint sensing area is a fingerprint, according to an example embodiment.

The fingerprint sensor 300 may obtain a sensing signal from one direction of a partial area of the fingerprint sensing area 101 in operation S10. The fingerprint sensor 300 may receive an analog sensing signal from each of pixels corresponding to the partial area of a pixel array (e.g., the pixel array 310 of FIG. 8) and may convert the analog sensing signal into a digital sensing signal, thereby obtaining a sensing signal.

The fingerprint sensor 300 may analyze frequency components of the sensing signal in operation S20. For example, the frequency analysis filter 323_1 included in the signal processor 323 of FIG. 8 may analyze a normalized spatial frequency of the sensing signal. For example, the frequency analysis filter 323_1 may be a digital IIR filter, and the digital IIR filter may extract a signal intensity or a power of a fingerprint frequency band among the normalized spatial frequency of the sensing signal.

The fingerprint sensor 300 may determine whether the object on the fingerprint sensing area is a fingerprint of a person, based on a frequency component corresponding to the fingerprint frequency band among the normalized spatial frequency of the sensing signal in operation S30. For example, the fingerprint sensor 300 may compare a signal intensity of entire frequency bands of the sensing signal with a signal intensity of the fingerprint frequency band, e.g., about 1.5 KHz to 4 KHz to determine whether the object is a fingerprint of a person. In an example embodiment, the fingerprint sensor 300 may determine that the object is a fingerprint of a person when the power of the fingerprint frequency band of the sensing signal is a predetermined ratio or more of the total frequency power.

In an example embodiment, the fingerprint sensor 300 may obtain a plurality of sensing signals from a plurality of directions in the partial area, and similarly to the above description, the fingerprint sensor 300 may determine whether the object is a fingerprint of a person, based on the normalized spatial frequency of each of the plurality of sensing signals.

A pattern direction of a fingerprint contacting the fingerprint sensing area 101 may be provided in plurality. Therefore, the fingerprint sensor 300 may obtain sensing signals in various directions and may analyze the obtained sensing signals to determine whether the object is a fingerprint of a person. In an example embodiment, the fingerprint sensor 300 may obtain the sensing signals in three or more directions.

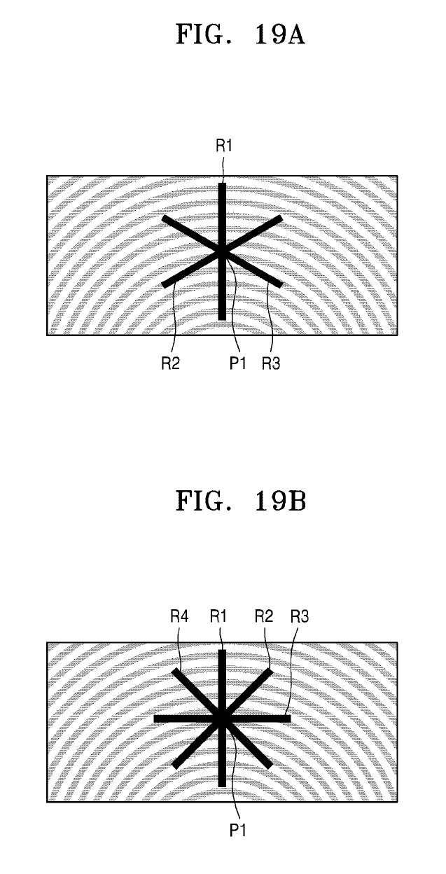

FIGS. 19A and 19B are diagrams showing directions in which a plurality of sensing signals are obtained in a fingerprint sensing area.

The fingerprint sensor 300, as shown in FIG. 19A, may obtain sensing signals in three directions R1 to R3 with respect to a center point P1, or as shown in FIG. 19B, the fingerprint sensor 300 may obtain sensing signals in four directions R1 to R4 with respect to the center point P1. However, this is merely an example. In other embodiments, the fingerprint sensor 300 may obtain sensing signals in two or more directions. In an example embodiment, the three directions R1, R2, R3 in FIG. 19A or the four directions R1, R2, R3, and R4 in FIG. 19B may be arranged at a uniform angle with respect to the center point P1 and each other. The fingerprint sensor 300 may determine whether the object is a fingerprint of a person based on the sensing signals obtained in at least two directions.

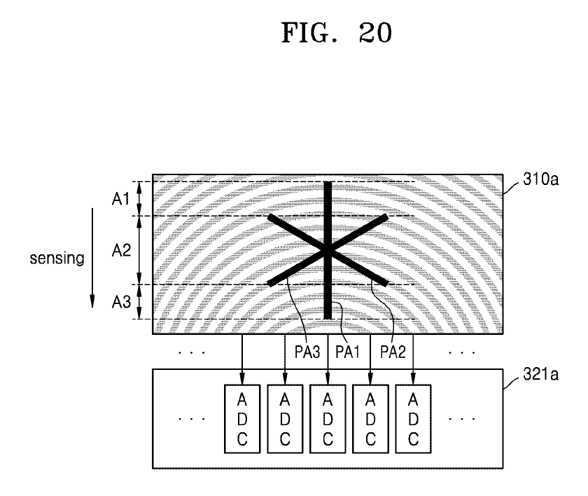

FIG. 20 is a diagram illustrating a method of obtaining a plurality of sensing signals in a plurality of areas corresponding to a plurality of directions in a fingerprint sensing area.

Referring to FIG. 20, a sensing circuit 321a of a fingerprint sensor may obtain a plurality of sensing signals from a plurality of areas of a pixel array 310a. The sensing circuit 321a may include a plurality of ADCs respectively connected to channels of the pixel array 310a. As illustrated, the areas may be sensed in units of one line in a direction from an upper portion to a lower portion of the pixel array 310a. In a case where the areas are sensed in units of one line, an ADC corresponding to a channel connected to a sensing pixel included in a sensed three direction areas, e.g., the first to third areas PA1, PA2 and PA3, may operate, and ADCs corresponding to channels respectively connected to sensing pixels included in a non-sensed partial area may not operate.

For example, when a section A1 and a section A3 are sensed, one ADC corresponds to the first area PA1 may operate, and when area section A2 is sensed, three ADCs correspond to the first to third areas PA1, PA2, and PA3 may operate in units of one line. An ADC which has received analog sensing signals may convert the sensing signal into a digital signal. Sensing signals (i.e., digital sensing signals) in three directions may be obtained by performing signal processing on the digital signals from ADCs.

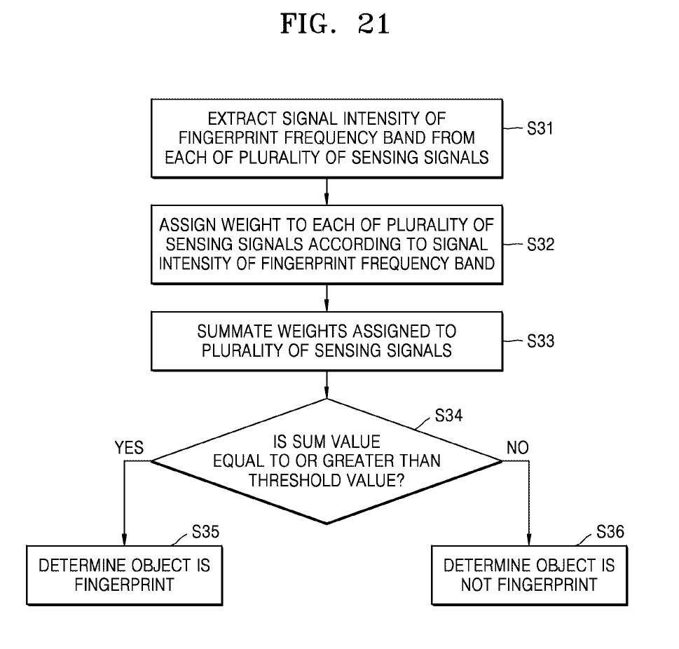

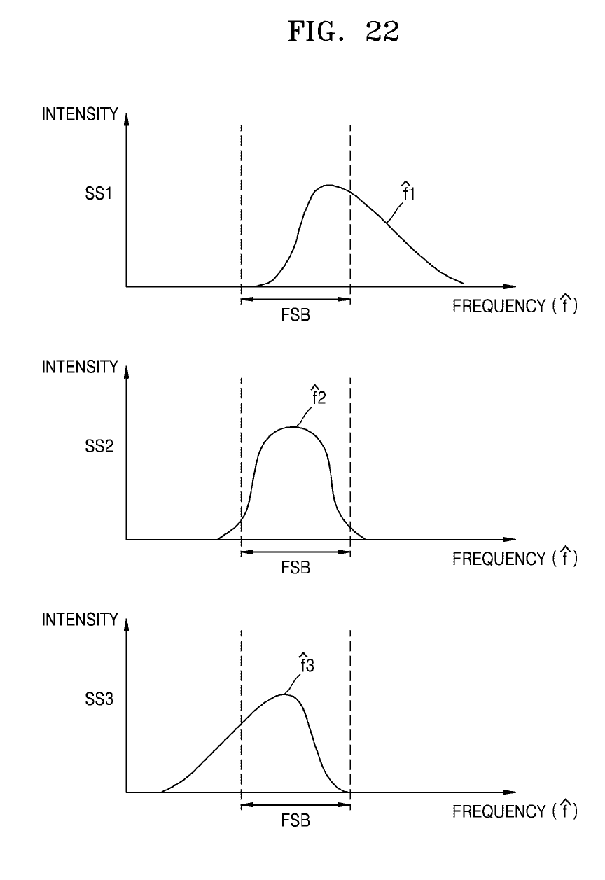

FIG. 21 is a flowchart for describing a method of determining whether an object on a fingerprint sensing area is a fingerprint, according to an example embodiment. FIG. 22 represents diagrams showing a signal intensity of each of a plurality of sensing signals on the frequency domain. FIG. 21 illustrates a method of determining whether a object is a fingerprint of a person, based on a plurality of sensing signals. The determination method of FIG. 21 may be performed by, for example, the controller 322 of the fingerprint sensor 300a of FIG. 8.

Referring to FIG. 21, a fingerprint sensor may extract a signal intensity of a fingerprint frequency band from each of the plurality of sensing signals in operation S31.

Referring to FIG. 22, for example, a normalized spatial frequency \hat{ƒ}1 of a first sensing signal SS1, a normalized spatial frequency \hat{ƒ}2 of a second sensing signal SS2, and a normalized spatial frequency \hat{ƒ}3 of a third sensing signal SS3 may represent different distributions.

Therefore, the signal intensities of the finger print frequency band FSB extracted from the first sensing signal SS1, the second sensing signal SS2, and the third sensing signal SS3 may be different.

The fingerprint sensor may assign a weight to each of the plurality of sensing signals according to the signal intensity of the fingerprint frequency band (FSB) in operation S32. Different weights may be assigned to each of the plurality of sensing signals.

The fingerprint sensor may summate weights assigned to the plurality of sensing signals in operation S33.

The fingerprint sensor may determine whether the sum value is greater than or equal to a threshold value in operation S34. For example, the threshold value may be set as a minimum value of sum values calculated through operations S31, S32, and S33, based on sensing signals obtained when a fingerprint of a person is scanned in a plurality of directions, for example, at least three directions.

When the sum value is greater than or equal to the threshold value, the fingerprint sensor may determine the object is a fingerprint of a person in operation S35. When the sum value is less than the threshold value, the fingerprint sensor may determine that the object is not a fingerprint of a person in operation S36.

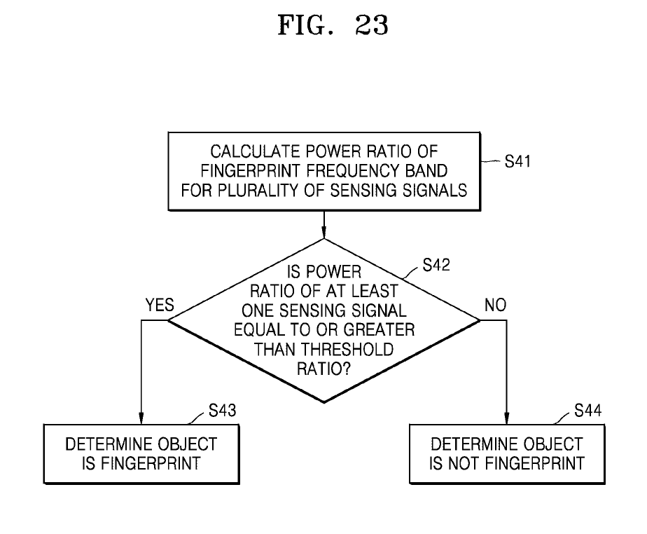

FIG. 23 is a flowchart for describing a method of determining whether an object on a fingerprint sensing area is a fingerprint, according to an example embodiment. FIG. 23 illustrates a method of determining whether the object is a fingerprint of a person, based on a plurality of sensing signals. The determination method of FIG. 23 may be performed by, for example, the controller 322 of the fingerprint sensor 300a of FIG. 8.

Referring to FIG. 23, a fingerprint sensor may calculate a power ratio of a finger print frequency band for each of a plurality of sensing signals in operation S41. For example, a ratio of a power of the fingerprint frequency band (FSB) to a power of the entire frequency band of the sensing signal may be calculated as the power ratio. To provide description with reference to FIG. 22, the fingerprint sensor may calculate the power ratio of the fingerprint frequency band to each of the first sensing signal SS1, the second sensing signal SS2, and the third sensing signal SS3. The power ratio of the second sensing signal SS2 may be the highest.

The fingerprint sensor may determine whether a power ratio of at least one sensing signal is greater than or equal to a threshold ratio in operation S42. For example, the fingerprint sensor may determine whether at least one of power ratios for each of the first to third sensing signals SS1 to SS3 is greater than or equal to the threshold ratio.

When the power ratio of the at least one sensing signals is greater than or equal to the threshold ratio, the fingerprint sensor may determine an object is a fingerprint of a person in operation S35. When the power ratio of the at least one sensing signal is less than the threshold ratio, namely, when power ratios of all sensing signals are less than the threshold ratio, the fingerprint sensor may determine that the object is not a fingerprint of a person in operation S36.

The method of determining whether an object on a fingerprint sensing area is a fingerprint of a person has been described above with reference to FIGS. 18 and 21 to 23. However, these are merely example embodiments. In other embodiments, the method of determining may be variously modified based on the above-described methods.

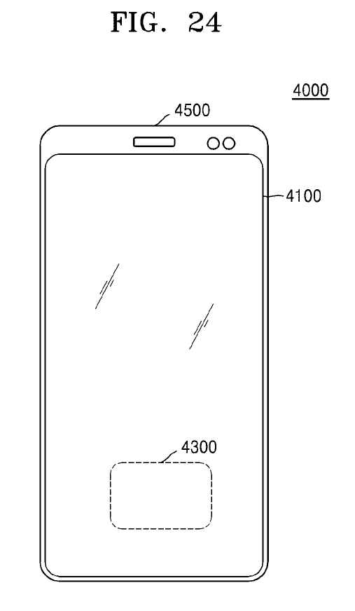

FIG. 24 is a diagram illustrating a smartphone 4000 according to an example embodiment.

Referring to FIG. 24, the smartphone 4000 may include a touch screen panel 4100, a touch screen housing 4500, and a fingerprint sensor 4300 disposed under the touch screen panel 4100. The smartphone 4000 may further include an AP, which controls an overall operation of the smartphone 4000, and a touch screen driving circuit (e.g., a display driving circuit and a touch controller) that drives the touch screen panel 4100.

The touch screen housing 4500 may constitute an exterior of the smartphone 4000 and protect the internal elements (e.g., integrated circuits (ICs), a battery, an antenna, etc.) of the smartphone 4000 from an external impact or a scratch.

The touch screen panel 4100 may perform displaying, touch sensing, and fingerprint sensing to operate as an input/output (I/O) device of the smartphone 4000. In an example embodiment, the touch screen panel 4100 may sense a force of a touch input. The touch screen panel 4100 may include a display layer and a touch sensing layer.

The display device 1000, the touch screen device 2000, and the mobile device 3000 respectively described above with reference to FIGS. 1, 10, and 13 may be applied to the smartphone 4000.

The fingerprint sensor 4300 may be disposed under (or behind) the touch screen panel 4100 and may perform fingerprint sensing, based on light irradiated from the touch screen panel 4100. Since a fingerprint sensing area overlaps a display area, a separate space for the fingerprint sensor is not required on a front surface of the smartphone 4000, and thus, an effective display area of the touch screen panel 4100 is not reduced.

Moreover, when the fingerprint sensor 4300 performs a fingerprint sensing operation, the smartphone according to an example embodiment may control the display driving circuit, thereby shortening a time for which pixels included in a display layer emit light having high luminance for fingerprint sensing. Accordingly, the display performance may be preserved for a longer lifespan.

Moreover, when an object contacts (or placed in close proximity to) a fingerprint sensing area, the fingerprint sensor 4300 may determine whether the object is a fingerprint, based on a partial image or sensing signals generated by scanning a partial area of the fingerprint sensing area. Only when it is determined that the object is a fingerprint of a person, the fingerprint sensor 4300 may generate a full fingerprint image and may provide the fingerprint image to an AP, thereby preventing the AP from performing an undesired fingerprint matching operation and decreasing a current consumption of a smartphone.

While the present disclosure has been particularly shown and described with reference to example embodiments thereof, it will be understood that various changes in form and details may be made therein without departing from the spirit and scope of the following claims.

1. A method of operating a fingerprint sensor, wherein the fingerprint sensor senses a fingerprint image based on light reflected from a fingerprint, the method comprising:
transmitting a first signal indicating a first request to turn on light emission, to a display driving circuit which drives a display panel disposed on the fingerprint sensor;
scanning an object on the display panel, based on light irradiated from the display panel; and
transmitting, to the display driving circuit, a second signal indicating a second request to turn off the light emission.

2. The method of claim 1, further comprising:
prior to the transmitting of the first signal, receiving a fingerprint sensing request signal from an external device; and
performing an internal circuit setup operation for fingerprint sensing in response to the fingerprint sensing request signal.

3. The method of claim 2, wherein the external device is one of a touch controller, an application processor, and a sensor hub.

4. The method of claim 2, wherein the fingerprint sensing request signal is received when a touch input occurs according to the object being placed within a threshold distance away from the display panel.

5. The method of claim 1, further comprising: after the transmitting of the second signal, processing sensing signals generated based on the scanning to generate a fingerprint image.

6. The method of claim 1, wherein the first signal comprises a light-on request signal and partial area information.

7. The method of claim 6, wherein the partial area information represents a partial area from which light is to be emitted, wherein the partial area belongs in a fingerprint sensing area of the display panel.

8. The method of claim 7, wherein a location the partial area which represented by the partial area information changes every time a fingerprint sensing request signal is received from an external device.

9. The method of claim 7, further comprising:
processing sensing signals generated based on the scanning to generate a partial image of the object; and
determining whether the partial image represents a human fingerprint.

10. The method of claim 9, further comprising: in response to determining that the partial image represents the human fingerprint, generating a fingerprint image of the object and providing the fingerprint image of the object to an external processor.

11. A display device comprising:
a display panel including a plurality of pixels;
a display driving circuit configured to drive the display panel to display an image; and
a fingerprint sensor disposed under the display panel and configured to sense a fingerprint, based on light emitted from at least one of the plurality of pixels of the display panel, by controlling turning-on and turning-off of light emission of the display panel.

12. The display device of claim 11, wherein the fingerprint sensor is further configured to transmit at least one of a light-on request signal and a light-off request signal to the display driving circuit to control the turning-on and the turning-off of the light emission of the display panel, respectively.

13. The display device of claim 12, wherein the display driving circuit is further configured to, in response to receiving the light-on request signal, drive the display panel to emit light from at least one partial area of the display panel.

14. The display device of claim 13, wherein the display driving circuit is further configured to change a location of the at least one partial area within the display panel every time the light-on request signal is received from the fingerprint sensor.

15. The display device of claim 12, wherein the fingerprint sensor comprises:
a pixel array including a plurality of sensing pixels; and
a sensing circuit configured to drive the pixel array and receive sensing signals provided by the pixel array to scan the fingerprint, and
wherein the sensing circuit is configured to, in response to a fingerprint sensing request signal being received from an external device, prepare for fingerprint scanning and transmit the light-on request signal to the display driving circuit.

16. (canceled)

17. A method of operating an electronic device including a touch screen and a fingerprint sensor stacked on the touch screen, the method comprising:
transmitting, by the fingerprint sensor, a light-on request signal to a display driving circuit which drives a display layer of the touch screen;
turning on, by the display driving circuit, light emission of display pixels provided in at least one area of a fingerprint sensing area of the touch screen, based on the light-on request signal; and
scanning, by the fingerprint sensor, an object on the touch screen, based on light irradiated from the touch screen.

18. The method of claim 17, wherein in response to a touch input applied to the touch screen, the fingerprint sensor changes from a low power mode to an operation mode, and
wherein the fingerprint sensor, in the operation mode, transmits the light-on request signal to the display driving circuit.

19. The method of claim 17, wherein, in response to a touch force being applied to the touch screen, the fingerprint sensor changes from a low power mode to an operation mode, and
wherein the fingerprint sensor, in the operation mode, transmits the light-on request signal to the display driving circuit.

20. (canceled)

21. The method of claim 17, further comprising: determining whether the object is a fingerprint of a person based on sensing signals generated by scanning the object.

22. The method of claim 21, further comprising:
in response to the fingerprint sensor determining that the object is the fingerprint of the person, transmitting a wake-up signal to an application processor;
obtaining, by the fingerprint sensor, a full fingerprint image corresponding to the object; and
transmitting, by the fingerprint sensor, the full fingerprint image to the application processor.

23.-28. (canceled)
